(19) United States
(12) Patent Application Publication
(10) Pub. No.: US 2005/0185676 A1
(43) Pub. Date: Aug. 25, 2005

(54) Multi access unit transport packetization method of MPEG4 sync layer packet and multi access unit transport packet

(75) Inventor: Yoon Seok Yang, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/051,632

(22) Filed: Jan. 27, 2005

(30) Foreign Application Priority Data
Jan. 27, 2004 (KR) 10-2004-0005053

(51) Int. Cl. H04J 15/00

(52) U.S. Cl. 370/503

(57) ABSTRACT

The present invention provides a multi access unit transport packetization method of an MPEG4 sync layer packet and a multi access transport packet, by which transmission efficiency is raised by removing redundancy of the MPEG4 sync layer packet of header data existing in a sync layer in case of transferring the MPEG4 sync layer packet via a transport medium. According to the present invention, the SL packets are bundled into a plurality of AU units to be packetized and a plurality of AUs are allowed to be transferred within one MATP packet, whereby the redundancy generated due to the SL packets us reduced as well as AUs can be effectively transferred. Specifically, the changed portion resulting from the examination of the previous and current AUs is allowed to be transferred, whereby the redundancy of the information coming by AU unit can be removed as well as the redundancy of the information coming by SL packet unit. Therefore, the present invention raises the transmission efficiency higher.

This application claims the benefit of the Korean Application No. 10-2004-0005053 filed on Jan. 27, 2004, which is hereby incorporated by reference.

### BACKGROUND OF THE INVENTION

1. Field of the Invention

The present invention relates to a multi access unit transport packetization method of an MPEG4 sync layer packet and a multi access transport packet, by which transmission efficiency is raised by removing redundancy of the MPEG4 sync layer packet of header data existing in a sync layer in case of transferring the MPEG4 sync layer packet via a transport medium.

2. Discussion of the Related Art

Generally, importance of an information delivery using a mobile medium gradually increases according to the tendency of new information delivery so-called convergence of communications and multimedia services. In delivering multimedia information via such a mobile medium, the information delivery using MPEG4 (moving picture experts group 4) is applied to various digital multimedia services. In these multimedia services, editing, storage, reuse, and the like of contents are actively accomplished. As the tendency of sending a stream, which is configured with various contents and contains vast data, within the limited communication resources rises, the utilization of MPEG4 gradually expands. Specifically, the use of the MPEG4 system for transferring various contents actively increases as well.

And, the MPEG4 system makes use of a sync layer to manage and transfer multimedia service contents.

FIG. 1A and FIG. 1B show structures of an MPEG4 sync layer packet in an MPEG4 transport structure. An MPEG4 sync layer (SL) packet is a system specification defined by MPEG4. In the MPEG4 system specification, the sync layer packet is defined to enable several multimedia contents to be transferred in a manner of sequentially synchronizing, multiplexing, and packetizing video, audio, BIFS (binary format for scene description), an access unit (AU), etc. In this case, the access unit (AU) is a minimum unit of MPEG4 data. Namely, an elementary stream (ES) as MPEG4 data in a compression layer lower than a sync layer is configured by the AU unit.

The SL packet consists of an SL header and an SL payload.

The SL payload carries real MPEG4 data configuring the AU. Namely, the payloads are real AU payloads, i.e., encoded media frames.

The SL header carries the information indicating what kind of data carried on the SL payload, as shown in FIG. 1, it is. Namely, the SL packet header, as shown in FIG. 1, is characterized in informing a beginning and end of the AU and transferring other information associated with the AU such as time information, bit rate information, AU length, and the like.

And, one AU is characterized in being configured with at least one SL packet, which means that it is unable to transfer several AUs via one SL packet.

Hence, to compensate such a disadvantage of the SL packet and to remove redundancy occurring in transferring one AU via several SL packets, various methods have been proposed.

One of the methods according to a related art is the RTP (real-time transport) packetization method of re-packetizing SL packets.

FIG. 2 is a diagram of the RTP packetization method according to a related art.

Referring to FIG. 2, an RTP header is configured from a plurality of SL packets to remove redundancy of the SL packets. And, size information of a payload of each SL header is loaded on a reduced header to be transferred. Namely, a redundant field is removed from the SL header of each of the SL packets configuring an RTP packet. And, reduced SL headers are made. And, the rest information within the SL header is included within RTP payloads together with SL packet payloads. A combination of the RTP header and the reduced SL packet headers can be used as a map of the RTP packet completing the SL packets logically.

Hence, it is able to remove the generated redundancy attributed to the SL packet header in case that a size of the SL packet is small.

However, the RTP packetization method configures the RTP packet in a manner that a user randomly selects the SL packet regardless of the AU.

Hence, the above-explained RTP packetization method has no choice but to reduce the redundancy by SL packet unit. Namely, the overlapped portions of the SL packets configuring one RTP can be removed only.

For instance, even if the SL packets included in the AU are configured within one RTP since the size of the AU is small, it is unable to reduce the redundancy of the incoming information by AU unit.

### SUMMARY OF THE INVENTION

Accordingly, the present invention is directed to a multi access unit transport packetization method of an MPEG4 sync layer packet and a multi access transport packet that substantially obviate one or more problems due to limitations and disadvantages of the related art.

An object of the present invention is to provide a multi access unit transport packetization method of an MPEG4 sync layer packet and a multi access transport packet, in which real-time transport packetization is performed in a manner of gathering SL packets not by random SL packet unit but by AU unit and by which redundancy of information coming by AU unit as well as by SL packet unit.

Another object of the present invention is to provide a multi access unit transport packetization method of an MPEG4 sync layer packet and a multi access transport packet, by which a plurality of AUs are loaded on one MATP packet to be transferred.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an MATP packet according to the present invention includes an MATP header, at least one MATP AU header generated by AU (access unit), and at least one MATP AU payload, wherein information generated using header information of a first sync layer (SL) packet of a first AU configuring the MATP packet is included in the MATP header, wherein information generated using header information of a first SL packet of a corresponding AU is included in the MATP AU header, and wherein payload information of entire SL packets within an AU indicated by the MATP AU header is included in the MATP AU payload.

Preferably, the MATP header includes OCR, DTS, and CTS values extracted from an SL packet from which the first AU starts at least.

Preferably, the MATP AU header includes a difference value between time information of a current AU and the time information of a previous AU.

More preferably, difference time information within the MATU AU header includes DOCR (difference of OCR), DDTS (difference of DTS), and DCTS (difference of CTS) values at least.

More preferably, initial reference values for calculating the DOCR, DDTS, and DCTS values between the two AUs correspond to OCR, DTS, and CTS values of the MATP header.

Preferably, the MATP AU header includes a difference value between the header information of a current SL packet and the header information of a previous SL packet.

In another aspect of the present invention, in re-packetizing SL packets to transfer a transport medium by configuring one access unit (AU) with at least one MPEG4 sync layer (SL) packet, an MATP packetization method of the SL packets includes the steps of generating multi AU transport (MATP) header information from header information of a first SL packet of a first AU, generating MATP AU header information from header information of a first SL packet of a corresponding AU, and generating MATP AU payload information by consecutively configuring payload information of the entire SL packets belonging to the AU.

Preferably, in the MATP header information generating step, time information is extracted from the first SL packet of the first AU and the time information includes OCR, DTS, and CTS values at least.

Preferably, the SL packets are packetized into an MATP packet with a plurality of AU units.

Preferably, the MATP AU header information generating step further includes the steps of if there is a new AU to be included in the MATP packet, generating new MATP AU header information from header information of the SL packet from which the new AU starts and generating new MATP AU payload information by consecutively configuring the payload information of the entire SL packets belonging to the new AU.

Preferably, time information within the MATU AU header is a difference value between the time information of a current AU and the time information of a previous AU.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1A and FIG. 1B are structural diagrams of an MPEG4 sync layer according to a related art;

FIG. 2 is an exemplary diagram of an MPEG4 sync layer packetization according to a related art;

FIG. 3 is a diagram of an MPEG4 sync layer packetization according to one embodiment of the present invention; and

FIG. 4A and FIG. 4B are structural diagrams of a packet of MATP in FIG. 3.

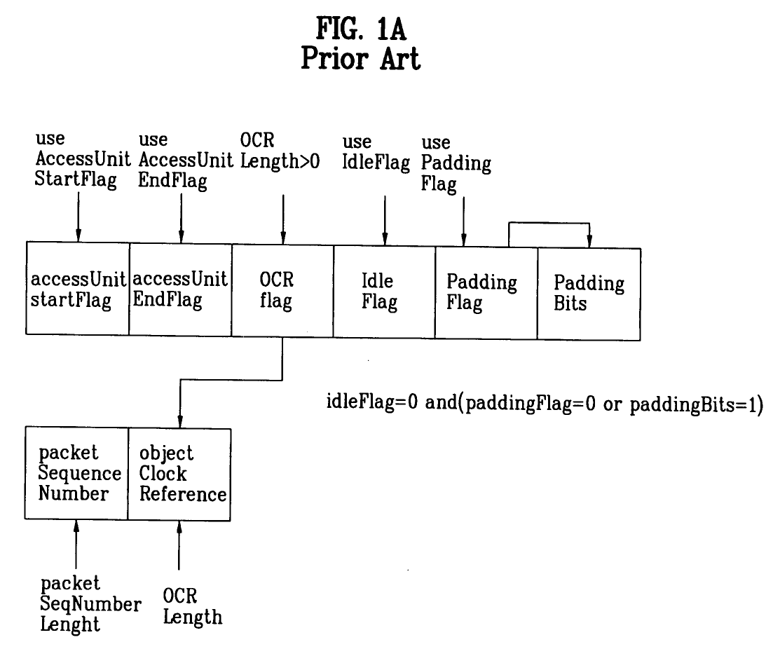

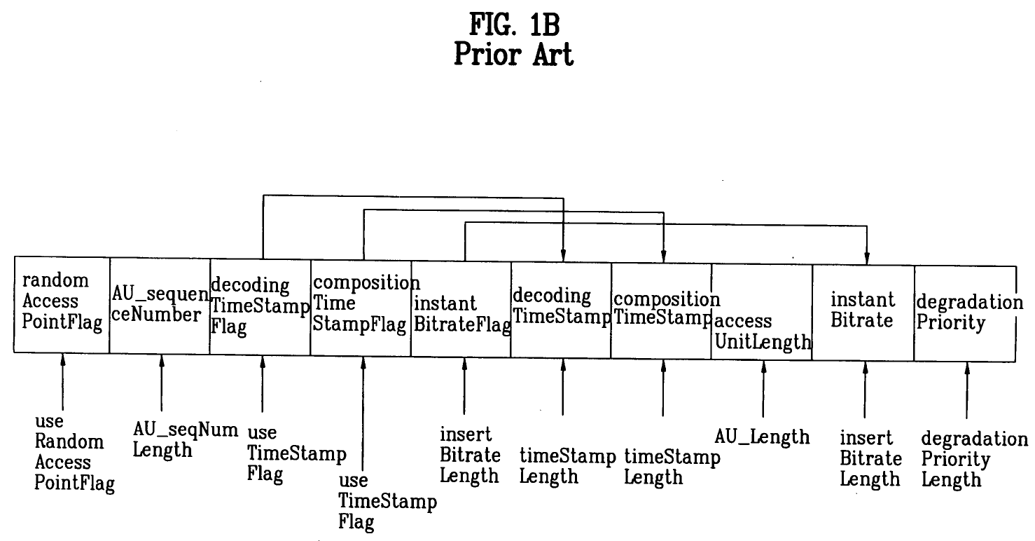

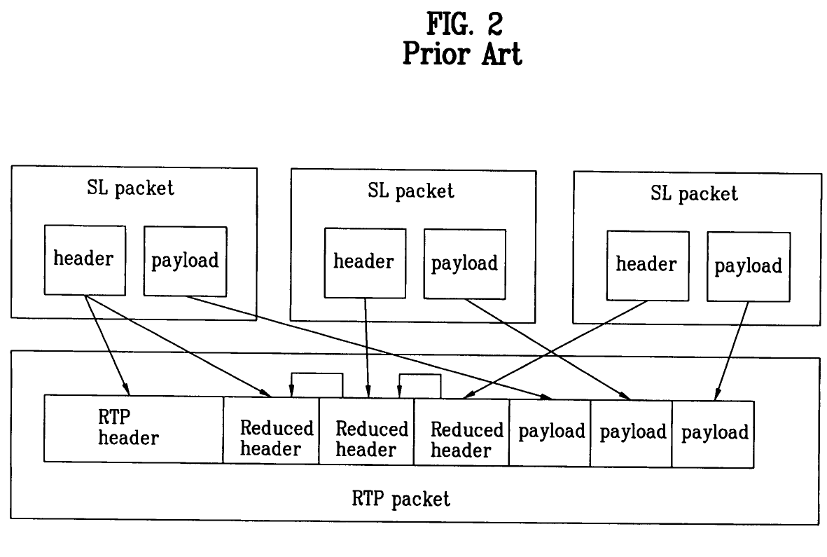

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

First of all, the present invention is devised to propose a new packetization method (multi AU transport: MATP) to remove redundancy of an SL packet header. In the MATP packetization method, SL packets are packetized in a manner of being bundled by a plurality of AU units to enable a transfer of multi AU. And, a new MATP header and an MATP AU header are defined to remove the redundancy of the SL packets.

In order to reduce the redundancy of the SL packet headers, the new MATP AU header is made to transfer a changed portion only after examining headers of previous and current SL packets. Hence, transmission efficiency is raised and the redundancy is removed. Specifically, in performing the MATP packetization by bundling the SL packets into a plurality of AU units, previous and current Aus are examined to transfer the changed portion only, whereby the transmission efficiency is raised higher and the redundancy of the information coming by AU unit can be removed.

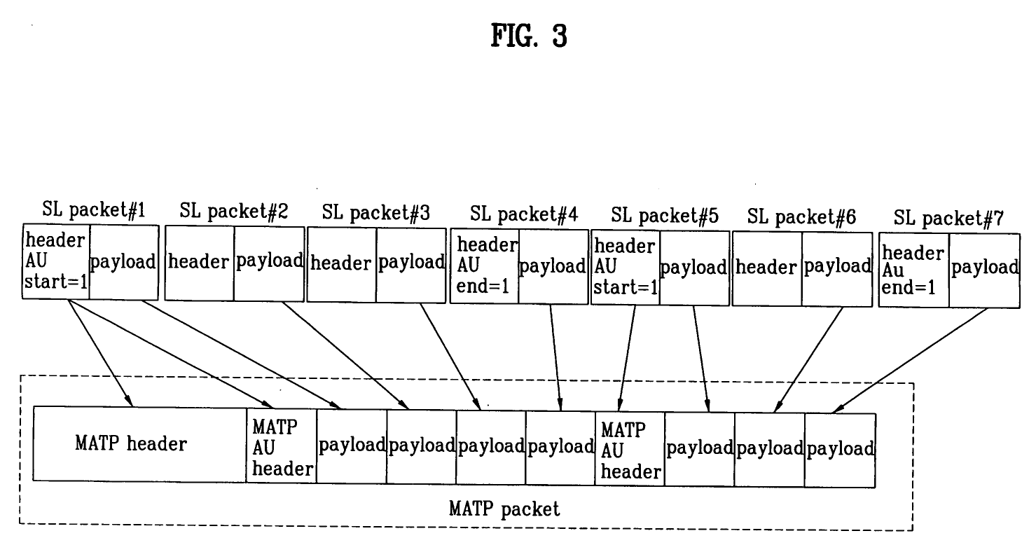

FIG. 3 shows an MATP packetization method according to the present invention. An MATP packet includes an MATP header, an MATP AU header, and an MATP AU payload.

First of all, the MATP header is generated from a header value of an SL packet with which the MATP packet will be configured. Specifically, information of the MATP header is generated from a header value of an SL packet from which a first AU starts. After completion of generating the MATP header, the MATP AU header for an AU that will be included in the MATP packet. The value is made using the header value obtained from the SL packet having AUStrartFlag=1, i.e., the SL packet from which the AU starts.

Once the MATP header is made, payloads of the SL packets belonging to the AU are sequentially transferred.

If a new AU starts, a new MATP AU header is generated again from a header value of the SL packet from which the new AU starts. And, payloads of the SL packets belonging to the new AU are sequentially transferred.

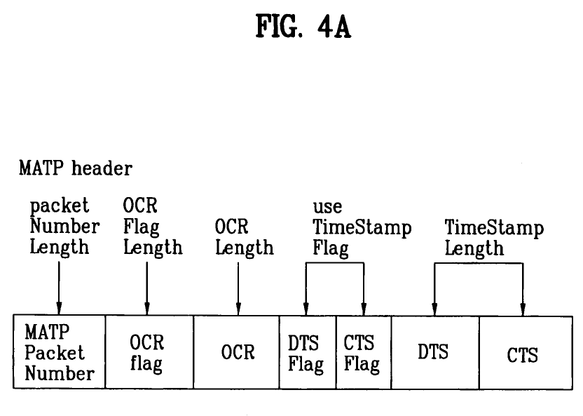

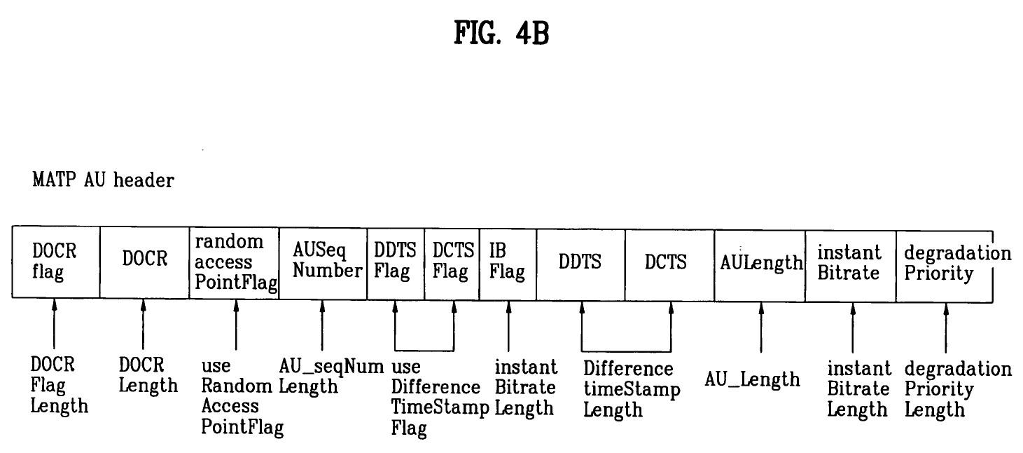

FIG. 4A shows a header of the MATP packet and FIG. 4B shows an example of an MATP AU header structure.

Referring to FIG. 4A, time information is extracted from an SL packet having AUStartFlag=1 to generate an MATP header. In this case, necessary time information includes OCR (object clock reference), DTS (decoding time stamp), and CTS (composition time stamp) values.

Even though the OCR value is transmitted for each SL packet in real SL packets, the OCR value is transferred by AU unit in generating the MATP packet.

And, an MATP AU header, as shown in FIG. 4B, is generated using an SL header having AUStartFlag=1. In doing so, the information coming by AU unit, which is a difference value of each AU from a previous AU, configures MATP AU header information.

There is time information among the information coming by the AU unit. Hence, the time information calculates the difference value from the previous AU and configures the MATP AU header with the difference value to transfer. In case of the time information, the difference values are DOCR (difference of OCR), DDTS (difference of DTS), and DCTS (difference of CTS) values. And, an initial reference value of the difference values of the OCR, DTS, and CTS values between AUs is calculated using the OCR, DTS, and CTS values of the MATP header. Thus, once the difference values are transferred, it is able to reduce the redundancy of the time information which occupies the largest portion of the real SL packet.

Moreover, if one MATP packet within one PES is transferred using the above-explained structure of MATP, a plurality of AUs can be transferred via one PES or TS (transport) packet in case of a small size of AU.

Meanwhile, the terminologies used in the description of the present invention are defined to take the functions in the present invention into consideration and may vary according to intentions or conventions of those skilled in the art. Hence, the definitions of the terminologies should be made based on the overall contents of the present invention.

As mentioned in the foregoing description of the MATP packetization method of the SL packet according to the present invention, the SL packets are bundled into a plurality of AU units to be packetized and a plurality of AUs are allowed to be transferred within one MATP packet, whereby the redundancy generated due to the SL packets us reduced as well as AUs can be effectively transferred. Specifically, the changed portion resulting from the examination of the previous and current AUs is allowed to be transferred, whereby the redundancy of the information coming by AU unit can be removed as well as the redundancy of the information coming by SL packet unit. Therefore, the present invention raises the transmission efficiency higher.

Moreover, by transferring a plurality of AUs via one MATP packetization, the present invention can solve the inefficiency of the RTP packetization occurring in case of the small-sized AU.

It will be apparent to those skilled in the art that various modifications and variations can be made in the present invention. Thus, it is intended that the present invention covers the modifications and variations of this invention provided they come within the scope of the appended claims and their equivalents.

1. An MATP packet comprising:
an MATP header;
at least one MATP AU header generated by AU (access unit); and
at least one MATP AU payload,
wherein information generated using header information of a first sync layer (SL) packet of a first AU configuring the MATP packet is included in the MATP header,
wherein information generated using header information of a first SL packet of a corresponding AU is included in the MATP AU header, and
wherein payload information of entire SL packets within an AU indicated by the MATP AU header is included in the MATP AU payload.

2. The MATP packet of claim 1, wherein the AU comprises at least one MPEG4 SL packet.

3. The MATP packet of claim 1, wherein the MATP header includes OCR, DTS, and CTS values extracted from an SL packet from which the first AU starts at least.

4. The MATP packet of claim 1, wherein the MATP AU header includes a difference value between time information of a current AU and the time information of a previous AU.

5. The MATP packet of claim 4, wherein difference time information within the MATU AU header includes DOCR (difference of OCR), DDTS (difference of DTS), and DCTS (difference of CTS) values at least.

6. The MATP packet of claim 5, wherein initial reference values for calculating the DOCR, DDTS, and DCTS values between the two AUs correspond to OCR, DTS, and CTS values of the MATP header.

7. The MATP packet of claim 1, wherein the MATP AU header includes a difference value between the header information of a current SL packet and the header information of a previous SL packet.

8. In re-packetizing SL packets to transfer a transport medium by configuring one access unit (AU) with at least one MPEG4 sync layer (SL) packet, an MATP packetization method of the SL packets, comprising the steps of:
generating multi AU transport (MATP) header information from header information of a first SL packet of a first AU;
generating MATP AU header information from header information of a first SL packet of a corresponding AU; and
generating MATP AU payload information by consecutively configuring payload information of the entire SL packets belonging to the AU.

9. The MATP packetization method of claim 8, wherein in the MATP header information generating step, time information is extracted from the first SL packet of the first AU and wherein the time information includes OCR, DTS, and CTS values at least.

10. The MATP packetization method of claim 8, wherein in the MATP AU header information generating step, the MATP AU header is configured with difference information between headers of the SL packets within the AU.

11. The MATP packetization method of claim 8, wherein the SL packets are packetized into an MATP packet with a plurality of AU units.

12. The MATP packetization method of claim 11, wherein in the MATP AU header information generating step, an MATP AU header is configured with difference information between AUs included in the MATP packet.

13. The MATP packetization method of claim 12, wherein time information within the MATU AU header is a difference value between the time information of a current AU and the time information of a previous AU.

14. The MATP packetization method of claim 12, wherein difference time information within the MATU AU header includes DOCR (difference of OCR), DDTS (difference of DTS), and DCTS (difference of CTS) values at least.

15. The MATP packetization method of claim 14, wherein initial reference values for calculating the DOCR, DDTS, and DCTS values between the two AUs correspond to OCR, DTS, and CTS values of the MATP header.

16. The MATP packetization method of claim 8, wherein the MATP AU header information generating step further comprising the steps of:
if there is a new AU to be included in the MATP packet, generating new MATP AU header information from header information of the SL packet from which the new AU starts; and
generating new MATP AU payload information by consecutively configuring the payload information of the entire SL packets belonging to the new AU.

17. In re-packetizing SL packets to transfer a transport medium by configuring one access unit (AU) with at least one MPEG4 sync layer (SL) packet, an MATP packetization method of the SL packets, comprising the steps of:
generating multi AU transport (MATP) header information from header information of a first SL packet of a first AU;
generating MATP AU header information from header information of the SL packet from which one AU starts; and
generating MATP AU payload information by consecutively configuring payload information of the entire SL packets belonging to the AU,
wherein the MATP AU header information generating step and the MATP AU payload information generating step are repeated as many as a number of AUs included in an MATP packet.

18. The MATP packetization method of claim 17, wherein in the MATP header information generating step, time information is extracted from the first SL packet of the first AU and wherein the time information includes OCR, DTS, and CTS values at least.

19. The MATP packetization method of claim 17, wherein in the MATP AU header information generating step, time information within an MATP AU header is generated from a difference value between the time information of a current AU and the time information of a previous AU.

20. The MATP packetization method of claim 19, wherein difference time information within the MATU AU header includes DOCR (difference of OCR), DDTS (difference of DTS), and DCTS (difference of CTS) values at least.

21. The MATP packetization method of claim 20, wherein initial reference values for calculating the DOCR, DDTS, and DCTS values between the two AUs correspond to OCR, DTS, and CTS values of the MATP header.
